(19) United States
(12) Patent Application Publication
(10) Pub. No.: US 2013/0041295 A1
(43) Pub. Date: Feb. 14, 2013

(54) STRETCH AND COMPRESS MUSCLE EXERCISE AND SIMULTANEOUS AEROBIC AND STRENGTH TRAINING EXERCISE METHOD FOR MOTIONLESS PATIENT OR NON-PATIENT [...] AS APPLIED TO ALZHEIMER, PARKINSON AND CANCER STUDIES

(71) Applicants: J. Frank KOENIG, Vienna, VA (US); John J. Basile, Potomac, MD (US)

(72) Inventors: J. Frank KOENIG, Vienna, VA (US); John J. Basile, Potomac, MD (US)

(21) Appl. No.: 13/652,880

(22) Filed: Oct. 16, 2012

Related U.S. Application Data
(63) Continuation-in-part of application No. 12/385,419, filed on Apr. 7, 2009, now Pat. No. 8,287,474.
Application No. 12/385,419 is a continuation-in-part of application No. 11/415,420, filed on May 2, 2006, now Pat. No. 7,513,879.
Application No. 11/415,420 is a continuation of application No. 10/645,869, filed on Aug. 22, 2003, now Pat. No. 7,037,257.
(60) Provisional application No. 60/404,933, filed on Aug. 22, 2002.

(51) Int. Cl. A61H 1/00; A61H 1/02

(52) U.S. Cl. 601/9; 601/10; 601/11

(57) ABSTRACT

Aerobic exercise and strength training exercise are simultaneously provided to the body of a motionless patient or non-patient, to gradually increase body strength, increase elasticities of limb arteries, veins and adjacent muscles, reduce heart workload, increase whole body blood flow, provide more oxygen and nutrients to the whole body, increase the rate of removal of cell waste products, to treat, prevent, reduce the rate of progression and reduce the risk of recurrence of diseases and conditions of the whole body. Apparatus provides stretching and compressing muscle exercise for hips, shoulders and limbs of motionless patient or non-patient. A new scientific explanation of aerobic exercise, e.g. walking, is provided which shows the sequence of events within the body during aerobic exercise which causes whole-body benefits shown in hundreds of aerobic exercise studies. The explanation is applied to Alzheimer, Parkinson and Cancer studies to explain the results of the studies.

### CROSS-REFERENCE TO RELATED APPLICATIONS

This application is a continuation-in-part of application Ser. No. 12/385,419, filed Apr. 7, 2009, now U.S. Pat. No. 8,287,474, issued Oct. 16, 2012, and which application Ser. No. 12/385,419 is a continuation-in-part of application Ser. No. 11/415,420, filed May 2, 2006, now U.S. Pat. No. 7,513,879, issued Apr. 7, 2009, and which application Ser. No. 11/415,420 is a continuation of application Ser. No. 10/645,869, filed Aug. 22, 2003, now U.S. Pat. No. 7,037,257, issued May 2, 2006, and which application Ser. No. 10/645,869 claims the priority of application No. 60/404,933, filed Aug. 22, 2002, and each of which is incorporated herein by reference.

This application relates to the following four (4) disclosure documents, each of which incorporated herein by reference:

1. Disclosure Document No. 510,869, filed May 6, 2002;

2. Disclosure Document No. 507,608, filed Mar. 19, 2002;

3. Disclosure Document No. 505,659, filed Feb. 20, 2002; and

4. Disclosure Document No. 499,108, filed Aug. 29, 2001.

Each of these four disclosure documents was filed with applicant's application Ser. No. 10/645,869, filed Aug. 22, 2003, now U.S. Pat. No. 7,037,257, issued May 2, 2006.

### FIELD OF THE INVENTION

The invention relates to an exercise apparatus which simultaneously provides aerobic exercise and strength training exercise to motionless patients and non-patients. The apparatus also provides stretching and compressing muscle exercise to motionless patients or non-patients.

### BACKGROUND OF THE INVENTION

We invented an erectile dysfunction treatment for men for whom medications are no longer effective, were never effective or are effective but the side effects are not tolerable.

In U.S. Pat. No. 7,037,257 to Koenig et al. we disclosed our finding that by momentarily causing dilation of penile arteries, to produce a firm penis, using the well-known hand vacuum pump, the arterial elasticity is temporarily increased, sufficient for sex, when used with an erectile dysfunction medication.

In our aerobic exercise patent application, Ser. No. 12/385,419, filed Apr. 7, 2009, now U.S. Pat. No. 8,287,474 to Koenig et al., issued Oct. 16, 2012, we showed that this finding for penile arteries is applicable to all of the arteries and veins in the whole body because all of those arteries and veins are of the same design since they have the same three layers in the vessel walls. A limitation of this finding is that artery and vein elasticity is only temporarily increased.

In our aerobic exercise patent application, Ser. No. 12/385,419, now U.S. Pat. No. 8,287,474, we disclosed a method and apparatus to gradually increase the elasticities of arteries, veins and adjacent muscles in the limbs, so that after all treatment sessions have been completed, the elasticities will remain at elevated levels, long term.

In our present application, we provide a method and apparatus to gradually increase the elasticities of arteries, veins and adjacent muscles in the limbs, by using our findings which uses, in part, the method of Wysor, U.S. Pat. No. 6,183,414.

Wysor conducted an erectile dysfunction study using 400 erectile dysfunction patients. He automated the well-known hand vacuum pump in order to perform the study. His apparatus repeatedly causes extra blood to be drawn into and out of the penile arteries to repeatedly cause erections, independent of sex.

Wysor found that after a large number of treatment sessions the men became sexually functional (normal), without erectile dysfunction medications or use of the hand pump. Eventually the men required additional treatment sessions in order to remain normal. The additional treatment sessions are required because, according to our finding, the elasticity of the penile arteries will gradually decrease over time, so that eventually the men will become sexually dysfunctional without additional treatment.

Wysor states that his treatment returned men to normal because, during treatment, the penile tissue became more elastic. Based on our finding in U.S. Pat. No. 7,037,257, a method to temporarily increase the elasticity of penile arteries, we concluded that Wysor's treatment gradually increased penile artery elasticity rather than penile tissue elasticity. We then formed the finding that repeated penile erections, independent of sex, gradually increased the elasticity of penile arteries, not the elasticity of penile tissue, as stated by Wysor.

Our finding also applies to penile veins and to all the arteries and veins of the whole body, because all arteries and veins of the whole body are of the same design since they have the same three layers in the vessel walls.

In our aerobic exercise invention, U.S. Pat. No. 8,287,474, we analyzed the method and apparatus known as EECP, used to increase whole body blood flow to treat diseases, described in the book by Dr. Debra Braveman, M.D.: Heal Your Heart with EECP.

EECP uses three pneumatic cuffs on each limb. The cuffs squeeze each limb in sequence.

EECP scientists found that whole body blood flow gradually increased over a series of treatment sessions. They concluded that this gradual increase in whole body blood flow was caused by a gradual decrease in heart workload, over a series of treatment sessions. They didn't state our more complete finding that the limb squeezing by the cuffs gradually increases the elasticities of limb arteries, veins and muscles to gradually reduce heart workload, to gradually increase whole body blood flow to treat and prevent diseases and conditions.

EECP is effective as shown in over 100 studies, when treating diseases and conditions of the whole body.

In our aerobic exercise patent application, we showed that EECP gradually increases the elasticities of limb arteries, veins and muscles, to gradually reduce heart workload, to gradually increase whole body blood flow to a high level, to treat and prevent diseases and conditions of the whole body.

Usually EECP patients require 1 hour per day, 5 days per week, for 7 weeks, in order to increase whole body blood flow to a high level. We showed that EECP gradually increases whole body blood flow for only a portion of each treatment session, while our treatment gradually increases whole body blood flow for 100 percent of each session. This suggests that we may require fewer than 35 sessions over 7 weeks, as is usually required by EECP, to increase whole body blood flow to a high level, long term. For EECP and for our treatment, eventually additional treatment sessions will be required because the elasticities of treated arteries, veins, and adjacent muscles will gradually decrease over time to increase heart workload and decrease whole body blood flow, according to our finding.

### BRIEF DESCRIPTION OF THE DRAWINGS

FIG. 1 shows the inventive apparatus applied substantially to a whole body.

FIG. 2 shows the inventive apparatus applied from above the knee to the foot.

FIG. 3 shows the inventive apparatus applied substantially to a whole arm.

FIG. 4 shows the inventive apparatus applied from above the knee to the ankle.

FIG. 5 shows a cycling positive chamber air pressure which causes the cycling headward force.

FIG. 6 shows a cycling negative chamber pressure which causes the cycling footward force.

FIG. 7 shows cycling positive and negative chamber pressures which cause cycling headward and footward forces.

### DETAILED DESCRIPTION OF THE INVENTION

The invention is a method and apparatus to simultaneously provide aerobic (cardio, endurance) physical exercise and strength (resistance, weight) training physical exercise to motionless patients and non-patients, using an air pressure chamber to enclose any portion of any limb that includes a foot or hand. We cycle the positive and negative chamber pressures to exercise the blood vessels and muscles within any limb, to gradually increase whole body blood flow and gradually increase body strength for the treatment, prevention, reducing the rate of progression and reducing the risk of recurrence of diseases and conditions of the whole body.

In our aerobic exercise invention, U.S. Pat. No. 8,287,474, we provide aerobic physical exercise for motionless patients and non-patients by means of an air pressure chamber enclosing any portion of any limb. This type of exercise is called “aerobic” because the body uses an increased amount of oxygen. Examples of aerobic exercise are walking, running, and walking or running on a treadmill.

While our aerobic invention, U.S. Pat. No. 8,287,474, provides only aerobic exercise, U.S. Pat. No. 5,133,339 to Whalen, simultaneously provides two types of exercise: aerobic (cardio, endurance) exercise and strength (resistance, weight) training exercise. The combination of both types of exercise provides more whole-body benefits than either type used separately.

Whalen provides aerobic exercise only by means of conventional aerobic exercise equipment, e.g. a treadmill, stair climber or the like. Whalen's patient or non-patient must move continuously to use this aerobic equipment, while we provide aerobic exercise for the motionless patient or non-patient on Earth or in Space. Whalen never provides aerobic exercise for the motionless patient or non-patient because his patients or non-patients must continuously move in order to use conventional aerobic exercise equipment.

Aerobic exercise and strength training exercise are discussed in Weight Training and Aerobic Exercise, the Best Combo to Protect Your Heart; UCLA David Geffen School of Medicine, newsletter, vol. 8, number 11, pages 1 and 7, Nov. 2011, and Harvard Medical School Special Health Report: “EXERCISE, a program you can live with;” 2012.

We use an air pressure chamber for aerobic exercise while Whalen uses conventional aerobic exercise equipment for aerobic exercise. We will show that Whalen's air pressure chamber provides only strength training exercise, not aerobic exercise.

In our U.S. Pat. No. 8,287,474, we found that cycling negative air pressure or cycling positive air pressure in a chamber will provide aerobic exercise to the motionless patient or non-patient by gradually increasing the elasticities of limb arteries, veins and adjacent muscles, to gradually reduce heart workload, to gradually increase whole body blood flow, to gradually provide more oxygen and nutrients to the whole body, to gradually increase the rate of removal of cell waste products, to provide whole body benefits, which are the treatment, prevention, reducing the rate of progression and reducing the risk or recurrence of diseases and conditions. Aerobic exercise benefits are shown in hundreds of exercise studies.

Whalen's Abstract provides an “exercise device (an air pressure chamber) to apply a high force to the body.” “The force, although not gravity, resembles gravity in its influence on the musculoskeletal mechanics of locomotion.” This external force has a “constant, controllable magnitude.” Column 3 lines 67-68: “The force is directed footward when the pressure outside the chamber is greater than the inside pressure (lower body negative pressure or LBNP), and headward when the inside pressure is greater (lower body positive pressure or LBPP).” The force is directly proportional to the pressure difference between inside and outside chamber pressures.

Whalen uses this external force, e.g. in outer space as a substitute for a lack of gravitational force in space, so that an astronaut's body in space is subjected to a constant external force similar to gravity on Earth. This constant force is needed in space in order to help maintain the astronaut's physiological condition. Simultaneously, Whalen provides the astronaut with a conventional treadmill, stair climber or the like for aerobic exercise for the continuously moving astronaut to help maintain the astronaut's physiological condition.

In contrast, we use an air pressure chamber with a cyclical positive air pressure and/or a cyclical negative air pressure to provide aerobic exercise for the continuously motionless patient or non-patient, to gradually increase the elasticities of limb arteries, veins and adjacent muscles, to gradually reduce heart workload, to gradually increase whole body blood flow, to gradually provide more oxygen and nutrients throughout the body, to gradually increase the rate of removal of cell waste products, to treat, prevent, reduce the risk of recurrence and reduce the rate of progression of diseases and conditions, in accordance with our finding in U.S. Pat. No. 8,287,474.

Whalen's air pressure chamber provides no aerobic exercise. Whalen provides aerobic exercise only with conventional aerobic exercise equipment, e.g. a treadmill. Whalen's patient or non-patient must move continuously in order to use conventional aerobic exercise equipment for aerobic exercise, while our patient or non-patient is continuously motionless when receiving aerobic exercise.

Whalen's air pressure chamber applies a controllable external force to the body. Strength training occurs whenever an external force is applied to the body.

Whalen's apparatus consists of an air pressure chamber, which provides only strength training exercise, in combination with conventional aerobic exercise equipment, which provides only aerobic exercise for the continuously moving patient or non-patient. Whalen, with this combination, simultaneously provides strength training exercise and aerobic exercise. Whalen can use his air pressure chamber separately, independent of the conventional aerobic exercise equipment, in order to provide only strength training exercise.

When the pressure inside a chamber is greater than the pressure outside of the chamber, there will be an outward external force on the walls of the chamber. When the pressure outside the chamber is greater than the inside pressure, there will be an inward external force on the walls of the chamber.

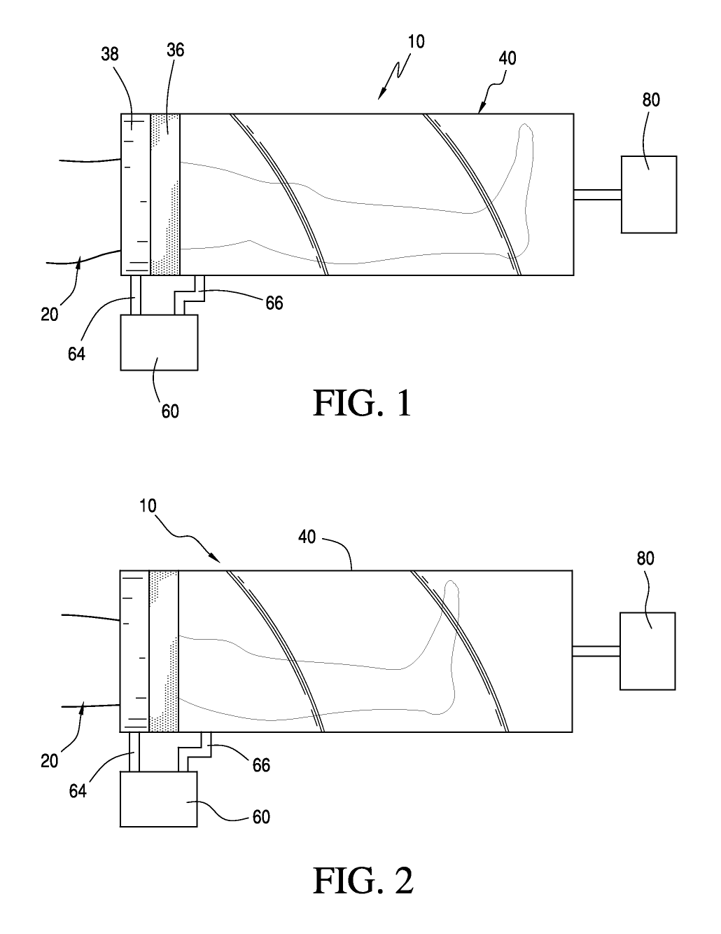

In FIG. 1a, e.g. Whalen uses an external force on the body. This external force is present in all air pressure chambers containing a portion of the body. Kravchenko, U.S. Pat. No. 3,465,748, does not use this external force. Kravchenko compensates for the presence of the external force by using a foot stop and waist strap (which are applicable to our invention) to prevent the external force from moving the enclosed limb footward or headward.

Whalen may be the first inventor to disclose a practical use for the external force on the body. Whalen uses this external force in outer space as a substitute for the absence of gravity.

We do not use the external force in our aerobic exercise invention, U.S. Pat. No. 8,287,474.

We will show herein that our present invention differs from and is an improvement over our aerobic exercise invention, as set forth in U.S. Pat. No. 8,287,474; indeed, our present invention differs from and is an improvement over the Whalen's strength training exercise invention to simultaneously provide aerobic exercise and strength training exercise for the motionless patient or non-patient using one air pressure chamber.

In column 2, lines 56-57, Whalen calls this force “a resultant external force, located at the centroid of the body cross-section in the plane of the seal, applied to the body when a difference in pressure, ΔP=P₂-P₁, exists between the outside and inside chamber pressure. P₁ is the air pressure inside the chamber and P₂ is the air pressure outside the chamber.

The external force F is described by the following equation:

F=ΔPA_{xy}

Where ΔP is the pressure difference across the seal and A_{xy} is the cross-sectional area of the body at the point of the seal.

The equation shows that for any cross-sectional area A_{xy}, the external force F is directly proportional to the pressure difference ΔP between the inside and outside chamber pressure, P₁ and P₂, respectively. The external force F is also directly proportional to A_{xy}, the cross-sectional area of the body at the seal.

The pressure outside the chamber is a constant ambient (atmospheric) pressure. In our aerobic exercise invention we cycle inside chamber negative pressure and/or cycle inside chamber positive pressure to provide aerobic exercise for the portion of the body located within the chamber. As the chamber inside pressure is cycled, to provide aerobic exercise, the cycling inside pressure also causes a cycling external force on the portion of the body located within the chamber. This cycling external force causes cyclical strength training, so that the cycling inside pressure simultaneously causes aerobic exercise and strength training exercise.

Using our FIG. 1 embodiment and using our negative pressure mode of operation (inside chamber pressure is lower than outside chamber pressure), a footward external force will cycle between zero and a controllable maximum external force to provide cyclical strength training exercise.

During our positive pressure mode of operation (inside chamber pressure is greater than outside chamber pressure), a headward external force will cycle between zero and a controllable maximum external force to provide cyclical strength training exercise. The patient or non-patient continuously and simultaneously receives the benefits of strength training exercise and aerobic exercise.

Exercise physiologists, medical doctors and physical therapists can control the number of cycles per minute and the maximum magnitude of the external force, as well as the variation of the external force, so that the treatment is adjusted to the condition of the patient.

In our present invention, which builds on our aerobic exercise invention, we simultaneously provide aerobic exercise and strength training exercise, using an air pressure chamber, while Whalen's invention simultaneously uses an air pressure chamber for only strength training exercise and a conventional treadmill, stair climber or the like for only aerobic exercise for the continuously moving patient or non-patient. Whalen's air pressure chamber is used only for strength training exercise, not aerobic exercise.

In our present invention we use an air pressure chamber to provide aerobic exercise for the continuously motionless patient or non-patient, while Whalen uses conventional aerobic exercise equipment to provide aerobic exercise for the continuously moving patient or non-patient who operates the conventional aerobic exercise equipment.

FIG. 1 of the present invention shows a first embodiment of an apparatus 10 according to the invention, applied to a whole leg 20. An elastomeric sleeve 36 connects to a vacuum chamber 40 to a pneumatic cuff 38. The cuff 38 seals the chamber 40 to the leg 20. Chamber 40 may be, e.g. plastic, transparent and cylindrical for ease of viewing by the medical personnel treating the leg 20 or arm 200 of a patient. An air compressor 60 is connected to the pneumatic cuff 38 by a pressure line 64. A vacuum pump 80 is connected to the chamber 40. The cuff pressure is adjusted high enough to provide a vacuum seal, without interfering blood flow.

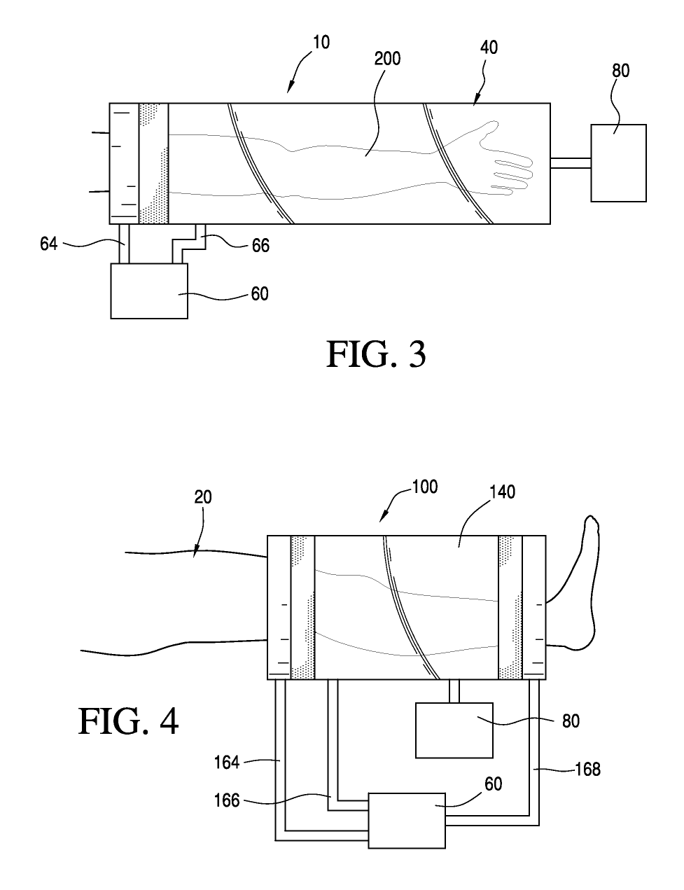

Additional passive (motionless patient or non-patient) exercise is achieved if the air compressor in FIGS. 1-5 is also connected to the chamber, as shown by the illustrated optional pressure lines 64, 66 and 164, 166, 168, respectively, of FIG. 4 showing an apparatus 100 according to the invention, with the vacuum pump turned off. Air pressure can be cycled to exercise arteries, veins, and adjacent muscles. When cycling, the maximum air pressure provided by respective compressors 60 and vacuum pumps 80 can be set for optimum exercise for the patient's condition, specified by exercise physiologists, medical doctors and physical therapists. A uniform air pressure is applied to the portion of the limb within the chamber. In FIGS. 1, 2 and 3 are shown chambers with one opening, which are useful when a chamber contains a whole limb or a portion thereof, including a hand or foot.

The external force on the limb is directly proportional to the pressure difference, between the inside and outside chamber pressure, and the cross-sectional area of the limb at the seal.

The external force on the limb is headward when the inside chamber pressure is higher than the outside chamber pressure, so that there is a positive pressure difference between inside and outside chamber pressures.

The external force on the limb is footward when the inside chamber pressure is lower than the outside chamber pressure, so that there is a negative pressure difference between inside and outside chamber pressures.

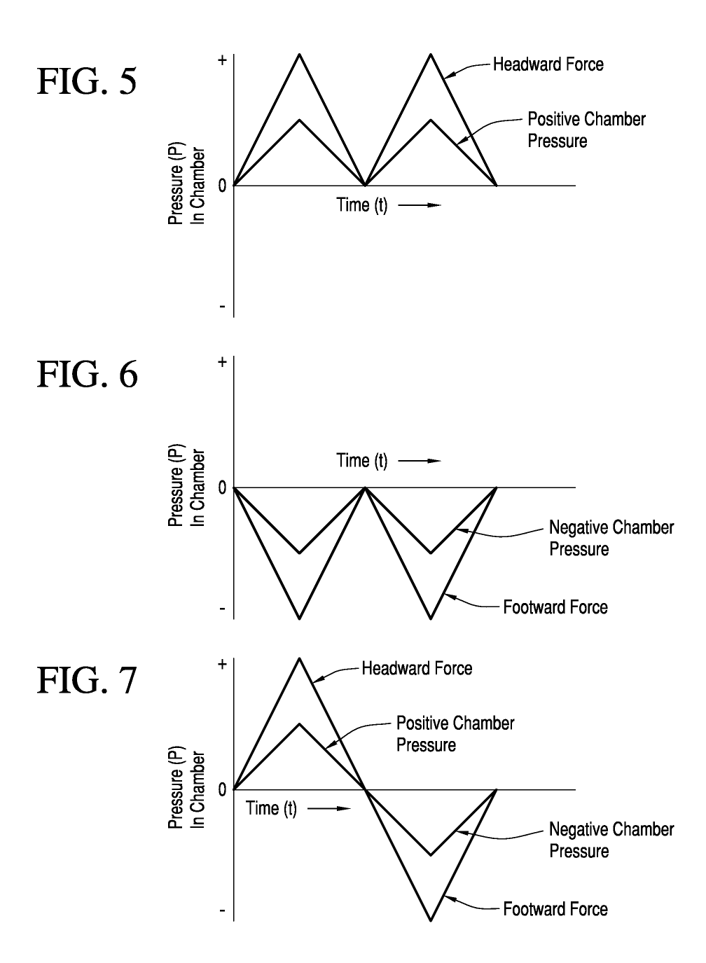

The outside chamber pressure is a constant ambient positive pressure. FIG. 5 shows, for the embodiments of FIGS. 1, 2 and 3, a cycling positive pressure difference between inside and outside chamber pressures, which causes a cycling headward force on the limb to provide cycling strength training exercise. Simultaneously the cycling positive chamber pressure difference causes aerobic exercise of the portion of the limb within the chamber. The headward force is directly proportional to the positive chamber pressure difference and the cross-sectional area of the limb at the seal.

FIG. 6 shows, for the embodiments of FIGS. 1, 2 and 3, a cycling negative pressure difference between inside and outside chamber pressures, which causes a cycling footward force on the limb to provide cycling strength training exercise. Simultaneously the cycling negative chamber pressure difference causes aerobic exercise of the portion of the limb within the chamber. The footward force is directly proportional to the negative chamber pressure difference and the cross-sectional area of the limb at the seal.

FIG. 7 shows, for the embodiments of FIGS. 1, 2 and 3, alternating positive and negative chamber pressure differences which cause the alternating headward and footward forces on the limb for strength training exercise. Simultaneously the alternating positive and negative chamber pressure differences cause aerobic exercise of the portion of the limb within the chamber. The headword and footward forces are directly proportional to the chamber pressure difference and the cross-sectional area of the limb at the seal. In FIG. 4, the chamber contains a portion of a limb, from above the foot to above the knee. Since the chamber has two openings, there are external forces inward or outward, at each opening. As shown earlier, the external force is located at the centroid of the limb cross-section in the plane of the seal.

When the inside chamber pressure is greater than the outside chamber pressure there is an outward headward external force on the chamber and at the centroid of the limb. This outward external force exists at both openings. The force is directly proportional to the cross-sectional area of the limb at each opening and the pressure difference.

In FIG. 4 the outward external force on the limb at the left chamber opening opposes the outward external force on the limb at the right chamber opening, so that the net force on the portion of the limb is the difference between the two forces.

In contrast, when the portion of the limb within the chamber includes a hand or foot, there is only one chamber opening and only one location of the external force on the limb.

When opposing forces are applied to a limb, either both inward or both outward forces, the net force on the limb is the difference between the two forces. Each opposing force is directly proportional to the pressure difference between the inside and outside chamber pressures and the cross-sectional area of the limb at the seal.

The opposing forces are equal only if the two limb cross-sectional areas are equal. When the two cross-sectional areas are unequal, the net force applied to the limb is the difference between the two forces. The inside chamber pressure can be cycled to cycle the net force for strength training exercise. Simultaneously, the cycling inside chamber pressure causes aerobic exercise, independent of the number of chamber openings. When the left opening limb cross-sectional area at the seal is greater than the right opening limb cross-sectional area at the seal, the external force at the left-opening limb centroid is greater than the opposing external force at the right-opening limb centroid. Chamber inside pressure can be cycled to simultaneously provide strength training and aerobic exercise. The cycling external force on the limb is the difference between the left cycling external force and the opposing right cycling external force.

The cycling inside chamber pressure is not limited to the sawtooth variation shown in FIGS. 5, 6 and 7. Any cyclical variation of the chamber pressure, specified by exercise physiologists, medical doctors and physical therapists, will provide aerobic exercise for the motionless patient or non-patient, as shown in our U.S. Pat. No. 8,287,474. In FIG. 7, e.g. the cyclical positive and negative chamber pressure variations can have the form of a sinusoidal pressure variation to simultaneously provide strength training and aerobic exercise for the motionless patient or non-patient.

It will thus be understood that the method according to the invention for providing simultaneous aerobic (cardio, endurance) physical exercise and strength (resistance, weight) training physical exercise for a motionless patient or non-patient, to simultaneously provide the whole body benefits of aerobic physical exercise and strength training exercise, which are the treatment and prevention of diseases and conditions includes, comprises, consists of, or consists essentially of:

a) providing a vacuum chamber, the vacuum chamber being configured for receiving a portion of patient's body that is remote from the heart, and the chamber being depressurizable;

b) providing a vacuum source operatively associated with the vacuum chamber, the vacuum source being configured for inducing a negative pressure in the vacuum chamber;

c) locating a portion of a patient's or non-patient's body in the vacuum chamber;

d) causing the vacuum source to induce a negative pressure on the portion of a patient's or non-patient's body remote from the patient's or non-patient's heart;

e) causing the vacuum source to relieve the negative pressure to return the pressure in the vacuum chamber to ambient pressure after a predetermined period of time; and

f) inducing and relieving the negative chamber pressure a sufficient number of times to simultaneously provide aerobic physical exercise and strength training physical exercise for the motionless patient or non-patient and to provide the whole body benefits of simultaneous aerobic exercise and strength training exercise, which are the treatment and prevention of diseases and conditions.

The method may further include the step of:

a) inducing and relieving the negative pressure independent of the patient's or non-patient's heartbeat.

It will further be understood that the method according to invention for providing simultaneous aerobic (cardio, endurance) physical exercise and strength (resistance, weight) training physical exercise for a motionless patient or non-patient, to simultaneously provide the whole body benefits of aerobic exercise and strength training exercise, which are the treatment and prevention of diseases and conditions, includes, comprises, consists of, or consists essentially of:

a) providing an air pressure chamber, the air pressure chamber being configured for receiving a portion of a patient's body that is remote from the heart, the chamber being pressurizable;

b) providing a positive air pressure source operatively associated with the air pressure chamber, the positive air pressure source being configured for inducing a positive air pressure in the air pressure chamber;

c) locating a portion of a patient's or non-patient's body in the air pressure chamber;

d) causing the positive air pressure source to induce a positive air pressure on the portion of the patient's or non-patient's body remote from the patient's or non-patient's heart;

e) causing the air pressure source to relieve the positive air pressure to return the pressure in the air pressure chamber to ambient pressure after a predetermined period of time; and

f) inducing and relieving the positive chamber air pressure a sufficient number of times to simultaneously provide aerobic physical exercise and strength training physical exercise for the motionless patient or non-patient and to provide the whole body benefits of simultaneous aerobic exercise and strength training exercises, which are the treatment and prevention of diseases and conditions.

That method may further include the step of:

a) inducing and relieving the positive chamber air pressure independent of the patient's or non-patient's heartbeat.

It will thus be understood that the method according to the invention for simultaneously providing aerobic (cardio, endurance) physical exercise and strength (resistance, weight) training physical exercise for motionless patients or non-patients, to simultaneously provide the whole body benefits of aerobic exercise and strength training exercise, which are the treatment and prevention of diseases and conditions, includes, comprises, consists of, or consists essentially of:

a) providing a chamber, the chamber being configured for receiving a portion of a patient's or non-patient's body that is remote from the heart, the chamber being pressurizable and depressurizable;

b) providing a positive chamber pressure source and a negative pressure source operatively associated with the chamber for inducing a positive chamber pressure or a negative chamber pressure in the chamber;

c) locating a portion of a patient's or non-patient's body in the chamber; and

d) alternately inducing and relieving the negative chamber air pressure and the positive chamber air pressure on the patient's or non-patient's body, to simultaneously provide aerobic exercise and strength training exercise for the motionless patient or non-patient and to provide the whole body benefits of simultaneous aerobic exercise and strength training exercise, which are the treatment and prevention of diseases and conditions.

That method may further include the step of:

a) inducing and relieving the negative chamber pressure and the positive chamber pressure independent of the patient's or non-patient's heartbeat.

### Stretching and Compressing Muscle Exercise

Stretching exercise enhances flexibility by stretching muscles. When done regularly, stretches can help you stay limber, improve your balance and posture, and possibly avoid injury. It is best to stretch after aerobic and/or strength training exercise, with our apparatus, when muscles are warm and limber. For best results, hold stretches for 10 to 30 seconds and do stretch exercises at least two or three times a week. The longer you hold a stretch, the better for flexibility.

Stretching exercise can be achieved with our combination aerobic-strength apparatus, for the motionless patient or non-patient. This apparatus also provides muscle compression exercise. Cycling stretching and compressing exercise can be provided by our apparatus.

For the embodiments of FIGS. 1, 2 and 3, stretching is achieved by using a positive chamber pressure which will apply an outward (headward) external force on any limb at the centroid of the cross-section in the plane of the seal when a pressure difference exists between the inside and outside chamber pressures. The stretching force is directly proportional to the cross-sectional area of the limb at the seal and the pressure difference at the seal.

When a positive chamber pressure is used the external force will not move any limb outward (headward) because adjustable hip and shoulder straps are used to prevent limb movement. The force will stretch limb muscles and compress hip or shoulder muscles. Each stretch is held constant for 10 to 30 seconds, for maximum benefit.

The external force can be fixed or variable. The magnitude of the force can be changed slowly for the safety of the patient or non-patient.

When a negative chamber pressure (inside chamber pressure is less than the outside chamber pressure) is used, the external force at the seal is inward (footward) so that hip or shoulder muscles outside (above) the enclosed limb are stretched. The footward or headward force at the seal will not move the limb due to a foot or hand plate within the chamber. While hip or shoulder muscles above the limb are stretched, the leg or arm muscles within the chamber are simultaneously compressed. The footward and headward forces can be cycled separately or alternately to provide stretching and/or compressing muscle exercise.

The above details the method according to the invention for providing muscle stretching and compressing physical exercise to any limb and adjacent hip or shoulder for a motionless patient or non-patient, to provide the benefits of muscle stretching and compressing, the method includes, comprises, consists of, or consists essentially of:

a) providing an air pressure chamber, the air pressure chamber being configured for receiving a limb of a patient's or non-patient's body, and the chamber being pressurizable;

b) providing a positive air pressure source operatively associated with the air pressure chamber, the positive air pressure source being configured for inducing a positive air pressure in the air pressure chamber;

c) locating a limb of a patient's or non-patient's body in the air pressure chamber;

d) causing the positive air pressure source to induce a positive air pressure on a limb of the patient's or non-patients body to simultaneously cause hip or shoulder muscles compression and limb muscles stretching;

e) causing the air pressure source to relieve the positive air pressure to return the pressure in the air pressure chamber to ambient pressure after a predetermined period of time;

f) providing a negative air pressure source operatively associated with the air pressure chamber, the negative air pressure source being configured for inducing a negative air pressure in the chamber;

g) causing the negative air pressure source to induce a negative air pressure on a limb of the patient's or non-patient's body to cause hip or shoulder muscles stretching and limb muscle compression;

h) causing the negative pressure source to relieve the negative pressure to return the chamber pressure to ambient pressure after a predetermined period of time; and

i) repeating steps d) through h) a sufficient number of times to provide a sufficient amount of stretching and compression exercise of hip, shoulder, and limb muscles.

### Scientific Understanding of Aerobic Exercise

Our aerobic exercise invention, U.S. Pat. No. 8,287,474, leads to a new scientific understanding of the sequence of events inside the body during aerobic exercise, e.g. walking, to cause the whole body benefits, which are the treatment, prevention, reducing the rate of progression and reducing the risk of recurrence of diseases and conditions of the whole body.

We apply this scientific explanation to Alzheimer, Parkinson and Cancer aerobic exercise studies and to a

Washington Post interview of Parkinson researchers and a Parkinson patient. Concerning regular aerobic physical exercise, e.g. walking, many whole-body benefits have been found in hundreds of studies.

It is known that the brain controls the contraction and relaxation of muscles, the driving force during aerobic physical exercise. It is known that regular aerobic physical exercise causes the active muscles throughout the body to become more elastic. We have shown in application Ser. No. 12/385,419, now U.S. Pat. No. 8,287,474, that regular dilation and relaxation of arteries and veins will gradually increase the elasticities of these vessels.

Our analysis shows that during aerobic physical exercise the active muscles, located throughout the body, regularly contract to squeeze the blood vessels within the muscles, so that the squeezing moves blood in the vessels to cause regular dilation and relaxation of the blood vessels to gradually increase the elasticity of the arteries and veins within the active muscles.

During each aerobic physical exercise session there is a gradual increase in the elasticity of arteries, veins, and active adjacent muscles, located throughout the body, to gradually reduce heart workload, to gradually increase the whole body blood flow, to gradually provide more oxygen and nutrients throughout the body, to gradually increase the rate of removal of cell waste products from the body, to provide the many whole-body benefits of regular aerobic physical exercise, in accordance with our finding in application Ser. No. 12/385,419, now U.S. Pat. No. 8,287,474.

During a series of aerobic exercise sessions the whole body blood flow will gradually increase during each session. The whole body blood flow, between successive sessions, will remain essentially constant because the elasticities of the arteries, veins and active muscles will remain essentially constant between successive sessions. During the next session the whole body blood flow will again gradually increase, as the elasticities of the arteries, veins and adjacent active muscles gradually increase, to gradually reduce heart workload, to gradually increase whole body blood flow, to gradually provide more oxygen and nutrients to the cell of the body, to gradually increase the rate of removal of cell waste products, to provide the whole-body benefits of regular aerobic physical exercise, which are the treatment, prevention, reducing the rate of progression and reducing the risk of recurrence of diseases and conditions of the whole body.

The whole body blood flow, over a series of exercise sessions, will gradually increase to a maximum level limited by the body. If a patient or non-patient stops exercising, the whole-body blood flow will gradually decrease as the elasticities of the arteries, veins and muscles gradually decrease. Regular aerobic exercise will maintain whole body blood flow at a high level to maintain maximum whole-body benefits.

Regular aerobic physical exercise, e.g. walking, or regular use of our inventive aerobic exercise apparatus will gradually increase whole body benefits by gradually increasing whole body blood flow over a serious of exercise sessions. Our aerobic exercise apparatus may provide all of the known regular physical exercise benefits found in hundreds of aerobic exercise studies.

We have shown that there is a gradual increase in whole body blood flow over a series of aerobic exercise sessions due to the gradual increase in the elasticities of the arteries, veins and adjacent active muscles, and the gradual decrease in heart workload.

Each muscle squeeze causes a small increase in the elasticity of each active muscle and adjacent arteries and veins, to cause a small reduction in heart workload, to cause a small increase in whole body blood flow, to provide a small increase in the amount of oxygen and nutrients provided to the whole body, to provide a small increase in whole body benefits.

Compared to walking, running is a faster means to increase the level of whole body blood flow to any specified level, because running provides more muscle squeeze per minute than walking.

### Alzheimer's Disease

Consider: 7 Surprising Findings about Exercise and Your Health, Tufts University Health and Nutrition Letter, April 2012. Finding #1, Exercise may negate extra genetic Alzheimer's risk, may be explained by our explanation of what occurs inside the body during aerobic exercise to cause whole-body benefits. In this Washington University of St. Louis study, using 163 participants, 52 were carriers of a genetic risk factor for Alzheimer's disease. The participants were divided into three groups:

1. Sedentary carriers of the genetic risk factor.

2. Physically active carriers of the genetic risk factor.

3. Participants without the genetic risk factor.

They found that the sedentary carriers had greater buildups of amyloid plaques in the brain associated with the development of Alzheimer's. But the carriers who were physically active, meeting the American Heart Association guidelines for regular exercise, showed no more buildup of amyloid plaques than found in the brains of non-carriers. They weren't certain how exercise caused these results.

Their results may be explained by our finding that regular aerobic exercise gradually increases whole body blood flow, so that the whole body receives more oxygen and nutrients to treat and prevent diseases. The sedentary carriers, due to a lack of regular exercise, had less oxygen and nutrients provided to the whole body, so that they suffered from oxygen and nutrients starvation, to cause a greater buildup of amyloid plaques in their brains.

### Parkinson's Disease

As cited in the book: Speed Healing, Bill Gottlieb, Bottom Line Books, 2009, page 263, researchers at the Harvard University School of Public Health analyzed 10 years of health data from more than 143,000 people with an average age of 63 and found that those who engaged in regular moderate to vigorous physical activity were 40% less likely to develop Parkinson's disease.

According to our finding, those who engaged in regular moderate to vigorous physical activity had a high level of whole body blood flow continuously so that the increased levels of oxygen and nutrients reduced the risk of Parkinson's, while the sedentary participants suffered from oxygen and nutrients starvation to increase the risk for the development of Parkinson's disease.

In a Washington Post article, Pushing Back, January 10, 2012, Alice Reid interviewed Parkinson disease researchers and a Parkinson patient, Chuck Linderman. For nearly a decade before his Parkinson diagnosis, he had been active in Alexandria Community Rowing's master program. “So his response to Parkinson's was immediate. Fight back with what he knew best: strenuous exercise.”

Since brain cell death begins a number of years before Parkinson's symptoms appear, Linderman's exercise program, prior to diagnosis, may have reduced the rate of progression of the disease, prior to the diagnoses, since our exercise explanation shows that regular aerobic exercise increases whole body blood flow, which provides more oxygen and nutrients to the brain, which benefits the brain's health before and after diagnosis.

Linderman's current exercise program exercises the upper and lower body. We have shown that the heart workload is determined by the elasticities of all of the muscles and blood vessels throughout the whole body. As heart workload gradually decreases, the level of whole body blood flow gradually increases. Our exercise explanation shows that Linderman's exercise program increases the level of whole body blood flow which may treat and reduce the rate of progression of Parkinson's disease. By exercising the muscles and blood vessels of the whole body, he is maximizing the level of whole body blood flow, when compared to exercising only the upper body or only the lower body, because the heart workload depends upon the elasticities of all of the arteries, veins and adjacent muscles in the whole body. The greater the elasticities of arteries, veins and muscles, the lower the heart workload, and the higher the level of whole body blood flow, to provide more oxygen and nutrients to the whole body to treat, prevent, reduce the rate of progression and reduce the risk of recurrence of diseases and conditions of the whole body. “Preliminary studies show that after eight weeks of cycling three times a week at a pace high enough to break a sweat and raise the heart rate, some Parkinson patients can recoup much of their mobility for nearly four weeks. After that, gains disappear unless the patient resumes exercising.”

Our exercise explanation shows that whole body blood flow gradually increased during eight weeks of cycling. During the subsequent four weeks, without exercise, the elasticities of the previously exercised arteries, veins and adjacent muscles gradually decreased, to gradually increase heart workload and gradually decrease whole body blood flow to provide less oxygen and nutrients to the brain and whole body, to cause a gradual return of Parkinson symptoms.

Jay L. Alberts, kinesiologist, a Parkinson's researcher at the Cleveland Clinic, rode a tandem bike with a Parkinson's patient across Iowa. Although the patient could not write her name legibly before the trip, “she could suddenly write her name clearly after the first day of strenuous cycling.” Later Alberts found similar results with other Parkinson patients.

Our exercise explanation shows that cycling causes a gradual increase in whole body blood flow, providing increased levels of oxygen and nutrients to the brain and whole body, to reduce Parkinson symptoms when the level of the whole body blood flow is sufficient.

Alberts conducted a stationary bike study. “After three-times-a-week sessions, nearly all Parkinson patients showed improvement in mobility and small motor skills.” And although cycling involves the legs, mobility improved elsewhere as well—“in manipulation—the ability to open a jar, for instance. Something global was happening in the brain,” Alberts said.

Our exercise explanation shows that cycling gradually increased the elasticities of leg arteries, veins and adjacent muscles, to gradually decrease heart workload, to gradually increase whole body blood flow, to gradually provide increased levels of oxygen and nutrients to the brain and the whole body, to improve brain performance and performance of the whole body, to reduce or eliminate the severity of symptoms. “When Alberts did brain scans on his research subjects they showed that exercise sparked blood flow and brain activity as effectively as the medications routinely prescribed for Parkinson's.”

Our exercise explanation shows that cycling caused gradually increasing whole body blood flow, which explains why Alberts brains scans showed increased blood flow in the brain, caused by lower body exercise.

According to our exercise explanation, if Alberts scanned the brain immediately after an exercise session and again immediately before the next exercise session, the level of blood flow may be essentially unchanged because the elasticities of leg arteries, veins and muscles will remain essentially constant between successive exercise sessions. During the next exercise session the whole body blood flow will again gradually increase as the elasticities of the arteries, veins and adjacent muscles gradually increase to reduce heart workload and increase whole body blood flow. After a sufficient number of exercise sessions, the whole body blood will have risen to a maximum level limited by the body.

If the patient stops exercising, the whole body blood flow will gradually decrease to the level at the beginning of the exercise program. The decreasing level of whole body blood flow is caused by the gradually decreasing elasticities of the leg arteries, veins and adjacent muscles, which gradually increase heart workload, to gradually decrease whole body blood flow.

“One of our goals is, can we delay the onset of symptoms. This is a neurodegenerative disease,” Alberts said. “If we can alter the slope of that progression, there is tremendous value here.”

Our exercise explanation shows that regular exercise will gradually increase whole body blood flow to a maximum level, limited by the whole body. Regular exercise will maintain the blood flow level at a maximum to provide maximum levels of oxygen and nutrients to the brain and whole body, which may reduce the rate of progression of Parkinson's disease. Linderman's years of strenuous exercise, prior to his Parkinson's diagnosis, caused his brain blood flow and whole body blood flow to rise to and remain at a high level, which may have reduced the rate of progression of his Parkinson's disease.

“Research has shown that when lab animals hop on treadmills or wheels, their brains produce increased blood flow and more synapses, or message paths, between brain cells. Their neurons fire with more energy.”

Our exercise explanation shows that the observed increased blood flow, which provides more oxygen and nutrients to the brain, causes improved brain performance due to the gradually increasing elasticities of the arteries, veins and adjacent active muscles, which gradually decreases heart workload, to gradually increase blood flow to the brain and whole body, which may treat, prevent and reduce the rate of progression of Parkinson's and other diseases throughout the whole body. Dr. Michael J. Zigmond, MD, neurologist, University of Pittsburgh Medical Center, is testing a hypothesis that might explain what's happening with Albert's patients and why Chuck Linderman is doing so well. “One thing Parkinson's does is it decreases the amount of compounds in the brain called neurotropic factors,” Zigmond said. “Our hypothesis is that exercise increases neurotropic factors, and they in turn protect the neurons that produce dopamine.” “In such a scenario, more exercise means survival for more dopamine-producing cells, which can slow the loss of mobility.”

Our exercise explanation shows that exercise gradually increases whole body blood flow, to gradually increase the levels of oxygen and nutrients to the brain and whole body, which gradually improves the performance of the brain and whole body, so that more dopamine-producing cells may survive, which may slow the loss of mobility. Increased levels of oxygen and nutrients may increase the amount of neurotropic factors to protect the neurons that produce dopamine.

“Alberts has shown that the pace of the exercise is important. By cycling intensely, Alberts speculated, you have information about a muscle movement going back to the brain. So if you can increase the quality and the quantity of that information, it may trigger biochemical changes in the brain.”

Cycling more intensely provides more muscle squeezes per minute than cycling less intensely. We have shown that each muscle squeeze increases the level of whole body blood flow a small amount, so that cycling intensely will increase whole body blood flow to a specified level in less time than cycling less intensely. Patients who can only cycle less intensely will require more time to increase their level of whole body blood flow to a high level than patients who are able to cycle more intensely, according to our aerobic exercise explanation. According to our exercise explanation, patients who are unable to exercise intensely may obtain intense exercise results by exercising for a longer time period.

### Cancer

Johns Hopkins Medicine, Health After 50, October 2012, discusses the American Cancer Society's (ACS) Nutrition and Physical Activity Guidelines for Cancer Survivors. The article's title: “Surviving Cancer: Steps You can Take to Guard Against Recurrence.”

“The guidelines, backed by years of research, advise how to improve survival and help prevent recurrence or the development of a secondary primary cancer.”

The guidelines include a healthy diet and sufficient regular physical activity. Our exercise explanation shows that sufficient regular exercise will gradually increase whole body blood flow, which provides more oxygen and nutrients to the whole body, which will remain essentially constant between successive exercise sessions. The increased whole body blood flow will provide more oxygen and nutrients to the whole body for the treatment, prevention, reducing the rate of progression and the risk of recurrence of diseases of the whole body. The maximum level of whole body blood flow is limited by the body.

“Studies of people with breast, colorectal, prostate and ovarian cancers consistently point to an association between regular exercise and decreased risk of cancer recurrence and improved overall survival. Active survivors benefit from improved heart and lung function, muscle strength, balance, mood, energy, self-esteem and quality of life.”

“Cancer survivors are at increased risk of developing chronic conditions like heart disease, diabetes or osteoporosis —in fact, almost half of all cancer survivors die of another condition. Following the ACS guidelines can help keep other cancers and diseases at bay. Encourage your family members to follow these guidelines, too. People whose family members have cancer run a higher risk of developing the disease. You're setting a good example for future generations by promoting healthy lifestyle behaviors that improve your survivorship status while reducing your loved one's risk of getting cancer one day.”

The ACS guidelines include a healthy diet (nutrients) and sufficient regular physical activity (exercise).

Our exercise explanation shows that sufficient regular aerobic exercise will gradually increase the elasticities of arteries, veins and adjacent active muscles, to gradually reduce heart workload, to gradually increase whole body blood flow, to provide more oxygen and nutrients to the whole body for the treatment, prevention, reducing the rate of progression and the risk of recurrence of diseases of the whole body.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

1. A method for providing simultaneous aerobic (cardio, endurance) physical exercise and strength (resistance, weight) training physical exercise for a motionless patient or non-patient, to simultaneously provide the whole body benefits of aerobic physical exercise and strength training exercise, which are the treatment and prevention of diseases and conditions, the method consisting essentially of:
a) providing a vacuum chamber, the vacuum chamber being configured for receiving a portion of patient's body that is remote from the heart, the chamber being depressurizable;
b) providing a vacuum source operatively associated with the vacuum chamber, the vacuum source being configured for inducing a negative pressure in the vacuum chamber;
c) locating a portion of a patient's or non-patient's body in the vacuum chamber;
d) causing the vacuum source to induce a negative pressure on the portion of a patient's or non-patient's body remote from the patient's or non-patient's heart;
e) causing the vacuum source to relieve the negative pressure to return the pressure in the vacuum chamber to ambient pressure after a predetermined period of time; and
f) inducing and relieving the negative chamber pressure a sufficient number of times to simultaneously provide aerobic physical exercise and strength training physical exercise for the motionless patient or non-patient and to provide the whole body benefits of simultaneous aerobic exercise and strength training exercise, which are the treatment and prevention of diseases and conditions.

2. A method according to claim 1, further including the step of:
a) inducing and relieving the negative pressure independent of the patient's or non-patient's heartbeat.

3. A method for providing simultaneous aerobic (cardio, endurance) physical exercise and strength (resistance, weight) training physical exercise for a motionless patient or non-patient, to simultaneously provide the whole body benefits of aerobic exercise and strength training exercise, which are the treatment and prevention of diseases and conditions, the method consisting essentially of:
a) providing an air pressure chamber, the air pressure chamber being configured for receiving a portion of a patient's body that is remote from the heart, the chamber being pressurizable;
b) providing a positive air pressure source operatively associated with the air pressure chamber, the positive air pressure source being configured for inducing a positive air pressure in the air pressure chamber;
c) locating a portion of a patient's or non-patient's body in the air pressure chamber;
d) causing the positive air pressure source to induce a positive air pressure on the portion of the patient's or non-patient's body remote from the patient's or non-patient's heart;
e) causing the air pressure source to relieve the positive air pressure to return the pressure in the air pressure chamber to ambient pressure after a predetermined period of time; and
f) inducing and relieving the positive chamber air pressure a sufficient number of times to simultaneously provide aerobic physical exercise and strength training physical exercise for the motionless patient or non-patient and to provide the whole body benefits of simultaneous aerobic exercise and strength training exercises, which are the treatment and prevention of diseases and conditions.

4. A method according to claim 3, further including the step of:
a) inducing and relieving the positive chamber air pressure independent of the patient's or non-patient's heartbeat.

5. A method for simultaneously providing aerobic (cardio, endurance) physical exercise and strength (resistance, weight) training physical exercise for motionless patients or non-patients, to simultaneously provide the whole body benefits of aerobic exercise and strength training exercise, which are the treatment and prevention of diseases and conditions, the method consisting essentially of:
a) providing a chamber, the chamber being configured for receiving a portion of a patient's or non-patient's body that is remote from the heart, the chamber being pressurizable and depressurizable;
b) providing a positive chamber pressure source and a negative pressure source operatively associated with the chamber for inducing a positive chamber pressure or a negative chamber pressure in the chamber;
c) locating a portion of a patient's or non-patient's body in the chamber; and
d) alternately inducing and relieving the negative chamber air pressure and the positive chamber air pressure on the patient's or non-patient's body, to simultaneously provide aerobic exercise and strength training exercise for the motionless patient or non-patient and to provide the whole body benefits of simultaneous aerobic exercise and strength training exercise, which are the treatment and prevention of diseases and conditions.

6. A method according to claim 5, further including the step of:
a) inducing and relieving the negative chamber pressure and the positive chamber pressure independent of the patient's or non-patient's heartbeat.

7. A method for providing muscle stretching and compressing physical exercise to any limb and adjacent hip or shoulder for a motionless patient or non-patient, to provide the benefits of muscle stretching and compressing, the method consisting essentially of:
a) providing an air pressure chamber, the air pressure chamber being configured for receiving a limb of a patient's or non-patient's body, the chamber being pressurizable;
b) providing a positive air pressure source operatively associated with the air pressure chamber, the positive air pressure source being configured for inducing a positive air pressure in the air pressure chamber;
c) locating a limb of a patient's or non-patient's body in the air pressure chamber;
d) causing the positive air pressure source to induce a positive air pressure on a limb of the patient's or non-patients body to simultaneously cause hip or shoulder muscles compression and limb muscles stretching;
e) causing the air pressure source to relieve the positive air pressure to return the pressure in the air pressure chamber to ambient pressure after a predetermined period of time;
f) providing a negative air pressure source operatively associated with the air pressure chamber, the negative air pressure source being configured for inducing a negative air pressure in the chamber;
g) causing the negative air pressure source to induce a negative air pressure on a limb of the patient's or non-patient's body to cause hip or shoulder muscles stretching and limb muscle compression;
h) causing the negative pressure source to relieve the negative pressure to return the chamber pressure to ambient pressure after a predetermined period of time; and
i) repeating steps d) through h) a sufficient number of times to provide a sufficient amount of stretching and compression exercise of hip, shoulder, and limb muscles.
